(19) United States
(12) Patent Application Publication
(10) Pub. No.: US 2025/0062552 A1
(43) Pub. Date: Feb. 20, 2025

(54) CABLE CONNECTION DEVICE AND ACTUATOR FOR A CABLE CONNECTION DEVICE

(71) Applicant: HARTING ELECTRIC STIFTUNG & CO. KG, Espelkamp (DE)

(72) Inventors: Markus WITTPAHL, Hüllhorst (DE); Luca BALTRUSCHAT, Minden (DE)

(21) Appl. No.: 18/721,568

(22) PCT Filed: Dec. 9, 2022
(86) PCT No.: PCT/DE2022/100936

§ 371 Date: Jun. 18, 2024

(30) Foreign Application Priority Data
Dec. 21, 2021 (DE) 10 2021 134 148.5

(51) Int. Cl. H01R 9/26

(52) U.S. Cl. CPC H01R 9/26

(57) ABSTRACT

A cable connection device with a contact carrier is provided and includes at least one bus bar, a contact arm for fixing an electrical conductor between the bus bar and the contact arm, and an actuator cooperating with the contact arm. The actuator is mounted such that it can move in a guide channel in an actuation direction between a released position and an actuated position, and wherein the actuator is divided into two, into a main body and a blocking body in such a way that, in the actuated position of the actuator, the blocking body can be moved relative to the main body in a blocking direction, that is different from the actuation direction, into a recess in an inner wall of the guide channel, in order to form a rear grip to block the actuator in the actuated position.

### BACKGROUND

### Technical Field

The present disclosure relates to a cable connection device and an actuator for such a cable connection device. The cable connection device includes a contact carrier, a busbar, a contact arm for fixing an electrical conductor between the busbar and the contact arm and an actuator cooperating with the contact arm.

### Description of the Related Art

Cable connection devices and actuators of the type above are required to connect an electrical conductor to the busbar electrically conductively with as little manual effort as possible and to mechanically fix it against unwanted removal, but also to be able to detach the electrical conductor from the busbar again, if necessary, with only minimal manual effort.

The document DE 10 2007 050 683 B4 discloses a cable connection device in which various types of actuating pushers can be integrated, which can be fixed in at least one actuated unlocking position. In one embodiment, a locking element that can be pulled against the actuating pusher is proposed in this publication. In further embodiments, it is proposed that the actuating pusher be guided in a guide channel, wherein a bay in the guide channel provides a free space so that a portion of the actuating pusher can be displaced in order to fix the actuating pusher in the unlocking position. This variant provides for the actuating pusher to have a flexible portion between the portion that is fixable in the bay and the portion that interacts with the spring-loaded clamping contact. This flexible portion allows the actuating pusher to be pivoted to one side into the bay in the guide channel. In this variant, the user must perform two translational movements with the tool during locking actuation, namely an actuating movement and—in the already inserted state—a locking movement perpendicular to the actuating direction, which requires a certain amount of skill and an understanding of the corresponding mechanics. Since the actuator is only latched to one side of the channel, the direction of latching is at least not self-explanatory to the user since the user cannot see into the interior of the contact carrier during actuation. A further decisive disadvantage of this design is that the middle part of the actuator, which is subjected to high mechanical stress during actuation, must be both highly stable and have the necessary elasticity. Particularly in the locked state, this bent region is exposed to high mechanical stress and corresponding wear due to the spring force. The portion of the actuator that serves to guide it in the housing is also inevitably very short, which makes it more difficult to guide.

The German Patent and Trade Mark Office has searched the following prior art in the priority application for the present application: DE 10 2007 050 683 B4, DE 10 2018 102 706 A1, DE 10 2020 122 135 A1, DE 10 2021 101 505 A1, DE 299 20 231 U1 and CN 102 969 592 A.

### BRIEF SUMMARY

Embodiments of the present disclosure are provided to improve the design and handling of a cable connection device and of an actuator for a cable connection device.

A cable connection device described herein initially has a contact carrier with a busbar. A contact arm is provided for fixing an electrical conductor to the busbar. The electrical conductor is, for this purpose, fixedly clamped between the busbar and the contact arm. The contact arm acts as a clamping arm or clamping leg. The term ‘contact arm’ chosen here is intended to express the fact that the electrical conductor must be subjected to the clamping force of the contact arm in order to establish permanent electrical and mechanical contact between the conductor and the busbar. An actuator interacting with the contact arm is used to actuate the contact arm. For this purpose, the actuator is mounted in a guide channel in the contact carrier so that it can be displaced between a released position and an actuated position. According to embodiments of the present invention, the actuator is divided into a main body and a locking body in such a way that, in the actuated position of the actuator, the locking body can be moved relative to the main body in a locking direction, different from the actuating direction, into a recess in the inner wall of the guide channel to form a rear grip to lock the actuator in the actuated position.

The cable connection device is used to press an electrical conductor, for example a strand of an electrical cable inserted into the contact carrier, against the busbar by the contact arm and thus connect it to the busbar electrically conductively and at the same time hold it mechanically on the busbar. In the so-called “push-in” technique, it is usually sufficient to insert the electrical conductor into a cable insertion opening on the contact carrier so that it is pushed between the contact arm, such as a clamping leg of a V-shaped clamping spring, and a contact portion of the busbar and is clamped between the contact arm and the contact portion of the busbar to prevent it from being pulled out against its insertion direction. This “push-in” connection technology is particularly user-friendly, as the manual effort is very low and can easily be carried out by the user with two hands. The actuator is then only used to release the connection, if necessary, by pressing down the contact arm.

However, this method requires a sufficiently rigid and stable electrical conductor. The individual wires of the strands must be numerous and stiff enough or the strand must be provided with a ferrule. However, if a less rigid stranded wire with a cross-section of less than 1.5 mm, for example, is inserted without a ferrule, it may not be able to move the contact arm away from the contact portion of the busbar, such as to bend it away. In this case, the actuator has a second function in which, in its actuated position, it moves the contact arm away from the contact portion of the busbar so that this thin stranded wire can be inserted at all. If the actuator is now released again, this thin stranded wire can also be clamped by the contact arm to the contact portion of the busbar and electrically conductively connected and secured against unintentional removal.

However, this is very uncomfortable to accomplish with two hands since the contact carrier and the cable must be held and the actuator actuated at the same time. With the present invention, however, the actuator can first be moved in the actuating direction to its actuated position in order to insert a thin strand of wire and move the contact arm away from the contact portion of the busbar. By moving the locking body in a locking direction different from the actuating direction relative to the main body into a recess in the inner wall of the guide channel, the locking body engages behind this recess and locks the actuator in its actuated position. As a result of this locking, the contact carrier can now be held with one hand and the wire or cable end can be inserted with the other. In this inserted position of the strand or the cable end, the contact carrier and the inserted cable can be easily held with one hand and the locking body can be unlocked again so that the actuator releases the contact arm and the contact closes automatically, which represents a considerable improvement in operating convenience compared to the aforementioned problem.

For example, such an operation can be carried out by a right-handed person as follows: first the actuator is actuated with the right hand using a screwdriver, then the actuator is locked with this same right hand using a screwdriver; the right hand is then free again; the cable is then taken with the right hand and inserted into the busbar; the cable is then transferred from the right hand to the left hand in the inserted state and held in place with the left hand (which, additionally, also holds the contact carrier); the right hand can now pick up the screwdriver again; and the right hand can now unlock the actuator.

The contact carrier can be held between the ring finger and the ball of the thumb with the left in hand. This means that the user can only hold the cable between the index finger and thumb, but not take and insert it. Advantageously, in this example, the right hand performs all movements in succession, which makes control and mental concentration during this process considerably easier.

It should also be noted that the cable connection described herein can also have several busbars and correspondingly several contact arms and several actuators. At least two variants of the locking body are provided, namely a locking body that can be displaced relative to the main body on the one hand and a locking body that can be rotated relative to the main body on the other.

The use of a longitudinal guide for the movable locking body facilitates simple and easy, and therefore user-friendly, relative movement of the locking body in relation to the main body. A dovetail guide also ensures a mechanically stable connection between the locking body and the main body.

In another embodiment, the locking body can be latched in its actuated position on the contact carrier by rotating the tool, such as the slotted screwdriver. On the one hand, this is self-explanatory. On the other hand, the rotary movement has no movement component in the actuating direction, so that the locking and actuating movements are strictly independent of each other. For this purpose, the locking body and the main body are connected to each other via a swivel joint.

In one embodiment, the guide can be configured in such a way that the main body and the locking body are initially firmly connected to each other and can only be moved against each other, such as moved or rotated against each other, after overcoming a resistance. This is also possible in the version with a swivel joint. For example, a predetermined breaking point can be provided between the main body and the locking body. The actuator can then also be used in cable connection devices in which no locking slide is required, for example in “push-in” connections with dimensionally stable cable ends. At the same time, unintentional disengagement between the main body and the locking body is prevented, which would, for example, increase the assembly effort of the cable connection device.

Furthermore, embodiments of the invention are suitable for producing the actuator using an “IMA—In Mold Assembling” process. In this process, different plastics are used for the main body and the locking body, which shrink differently during cooling so that they do not weld together. This creates a certain amount of play between the main body and the locking body so that they can move relative to each other.

A tool engagement point, for example a slot for a screwdriver, is advantageously molded into the end of the locking body facing away from the main body. In this way, the actuator can first be pressed down vertically with the screwdriver in the direction of actuation and then the locking body can be moved into a recess in the inner wall of the guide channel by a horizontal lateral displacement. In the version with a swivel joint, the locking body can be rotated relative to the main body using the screwdriver.

This embodiment is able to increase the ease of operation, since—in contrast to the prior art mentioned at the outset—two independent movements are used for actuation or locking after the rotation is completely decoupled from the translation.

### BRIEF DESCRIPTION OF THE SEVERAL VIEWS OF THE DRAWINGS

Embodiments of the present disclosure are explained below with reference to the figures.

FIG. 1 shows a perspective view of a first embodiment of an actuator with a locking body which is displaceable relative to the main body.

FIG. 2 shows a sectional view of a contact spring and a busbar with the actuator from FIG. 1 in its actuated position.

FIG. 3 shows a detailed sectional view of the actuator according to FIG. 1 in its released position in the guide channel of a cable connection device.

FIG. 4 shows a detailed sectional view of the actuator according to FIG. 1 when it reaches its actuated position in the guide channel of a cable connection device.

FIG. 5 shows a detailed sectional view of the actuator according to FIG. 1 in its actuated position in the guide channel of a cable connection device with the locking body displaced into a recess in the inner wall of the guide channel.

FIG. 6 shows an exploded view of a second embodiment of the actuator with a locking body that is rotatable relative to the main body.

FIG. 7 shows a perspective view of the actuator from FIG. 6 in its released position.

FIG. 8 shows a perspective view of the actuator from FIG. 6 in its actuated position.

The figures contain partially simplified, schematic representations. Identical reference signs are used for identical and structurally like parts. Different views of the same parts may be scaled differently.

### DETAILED DESCRIPTION

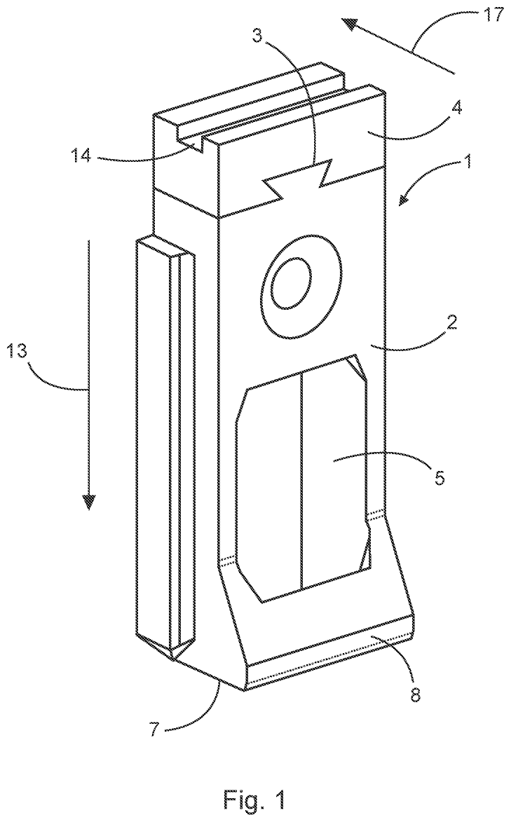

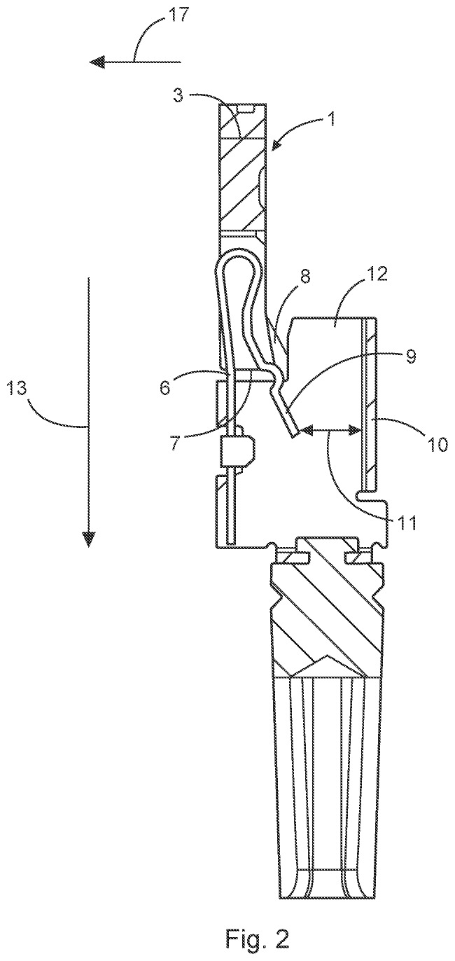

The actuator 1 shown in FIG. 1 in its first embodiment consists of a base-like, substantially cuboid main body 2 and a locking body 4 connected to the main body 2 via a dovetail guide 3 at an upper end of the main body 2. A receiving chamber 5 for a contact spring 6 is molded into the end of the main body 2 facing away from the locking body 4. The end 7 of the main body 2 facing away from the locking body 4 is open. With this open end 7, the main body 2 can be slipped over the contact spring 6 in such a way that the contact spring 6 lies at least partially in the receiving chamber 5, which can be seen in FIG. 2.

FIG. 2 shows the actuator 1 in its actuated position. In this actuated position, an actuating web 8 formed at the end 7 of the main body 2 acts on a contact arm 9 of the contact spring 6. In this way, the contact arm 9 is pivoted away from a busbar 10 opposite it, so that a gap 11 is opened up between a free end of the contact arm 9 and the busbar 10, into which gap the end, such as a strand of an electrical conductor or cable not shown in the figures, can be inserted from above through a cable insertion opening 12.

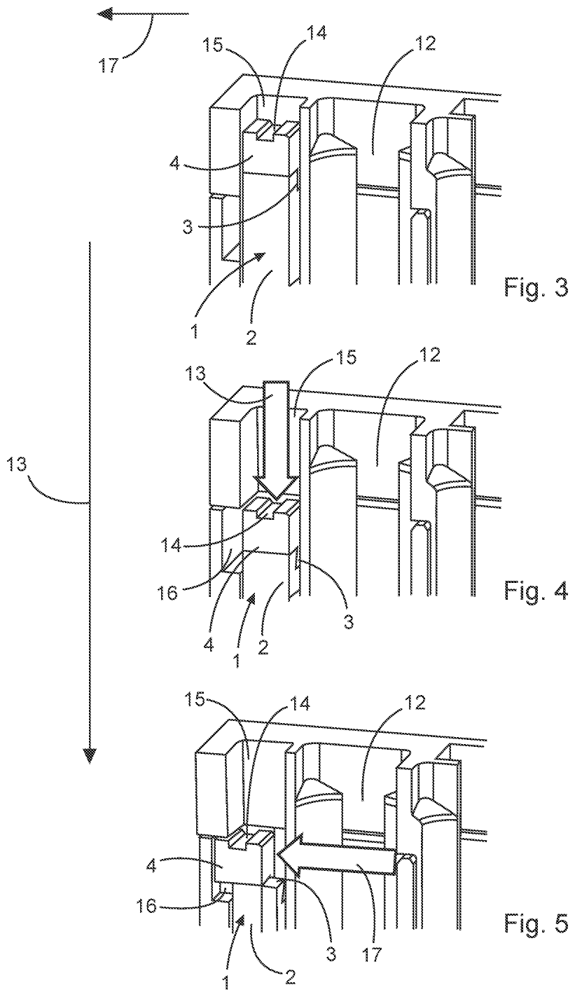

Once the conductor end or strand end has been inserted or the gap 11 is to be closed again, the actuator 1 is moved vertically upwards against its actuating direction 13. The actuating web 8 releases the contact arm 9 of the contact spring 6 so that the contact arm 9 swings out approximately at right angles to the actuating direction 13 in the direction of the busbar 10 and closes the gap 11. The actuator 1 is then moved back from its actuated position to its released position, as shown in FIG. 3.

In order to move the actuator 1 from its released position shown in FIG. 3 back into its actuated position, a slot 14 is formed in an upper side of the locking body 4 as an engagement for a screwdriver blade of a screwdriver. The screwdriver is used to press the actuator 1 vertically downwards in the actuating direction 13. In the process, the actuator 1 moves vertically downwards in its guide channel 15 in the contact carrier in the actuating direction 13 until it reaches its actuated position shown in FIG. 4.

A recess 16 is formed in an inner wall of the guide channel 15. In the actuated position of the actuator 1 in one embodiment, the screwdriver blade is moved at right angles to the actuating direction 13 in a locking direction 17 to the left, whereby the locking body 4 is displaced along the dovetail guide 3 in the locking direction 17 relative to the main body 2 into the recess 16, as shown in FIG. 5. The locking body 4 slides into the recess 16 in the manner of a pawl and forms a rear grip with an upper edge of the recess 16. The actuator 1, in its actuated position, is then form-fittingly secured in the recess 16 by the locking body 4.

In this actuated position of the actuator 1 shown in FIG. 5, the gap 11 is again completely open and can be fitted with cable ends, such as strands, without having to hold the actuator 1 in place. As soon as the gap 11 is to be closed again, the locking body 4 is moved with the screwdriver blade in the slot 14 against the locking direction 17 until the outer surfaces of the main body 2 and the locking body 4 are aligned with each other, so that the rear grip of the locking body 4 in the recess 16 is deactivated again. The actuator 1 then automatically returns to its initial position in the guide channel 15, as shown in FIG. 3, against the actuating direction 13 due to the resetting spring force.

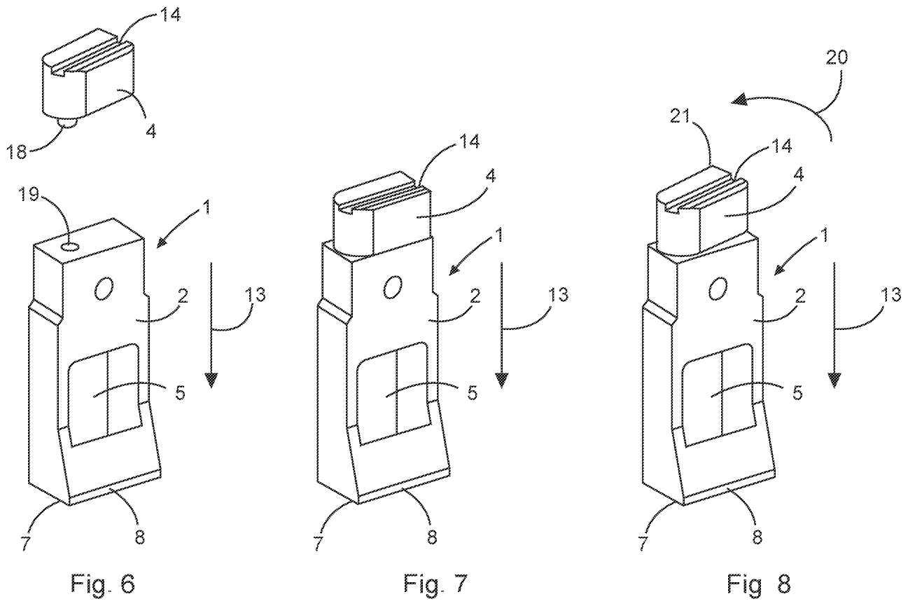

FIGS. 6, 7 and 8 show the actuator 1 in a second embodiment. By comparing FIG. 1 with FIG. 6, it can be seen that the structure of the main body 2 of both actuators 1 is largely identical. Only the locking body 4 and its connection to the main body 2 are different. Whereas in the first embodiment according to FIG. 1 to FIG. 5, the locking body 4 is mounted so as to be displaceable relative to the main body 2, in the second embodiment according to FIG. 6 to FIG. 8, the locking body 4 is mounted so as to be rotatable relative to the main body 2.

In the embodiment in FIG. 6, a bearing bolt 18 protrudes downwards from an underside of the locking body 4 facing away from the slot 14. A bearing bore 19 is provided in the upper side of the main body 2, into which the bearing bolt 18 can be inserted. The bearing bolt 18 and the bearing bore 19 together form a swivel joint. A comparative view of FIG. 7 and FIG. 8 shows that the locking body 4 can be pivoted in a direction of rotation 20 relative to the main body 2 when the bearing bolt 18 is inserted into the bearing bore 19.

FIG. 7 shows the actuator 1 in its released position. In this released position, the locking body 4 rests on the main body 2 in such a way that outer surfaces of the main body 2 and the locking body 4 are aligned with each other. The actuator 1 can thus be moved in the guide channel in the actuating direction 13 into its actuated position. To do this, a screwdriver blade engages in the slot 14 on the locking body 4 and presses the actuator 1 downwards in the actuating direction 13. As soon as the actuator 1 has reached its actuated position, the screwdriver blade is turned in the direction of rotation 20. With this rotation of the screwdriver blade in the slot 14, the locking body 4 also performs a rotary movement in the direction of rotation 20 relative to the main body 2. The outer surfaces of the main body 2 and the locking body 4 are no longer aligned with each other, but an end edge 21 of the locking body opposite the pivot bearing formed by the bearing bore 19 and the bearing pin 18 on the locking body 4 protrudes beyond the outer contour of the main body 2 and engages in the recess 16 formed on the inner wall of the guide channel 15. The end edge 21 of the locking body 4 and its adjacent region are thus displaced into the recess 16 relative to the main body 2. The locking body 4 slides into the recess 16 in the manner of a locking pawl and forms a rear grip with the upper edge of the recess 16. The actuator 1 is then form-fittingly secured in the recess 16 by the locking body 4 in its actuated position.

In this actuated position of the locking body 4 shown in FIG. 8, the gap 11 between the busbar 10 and the contact arm 9 is completely open and can be fitted with cable ends, such as strands, without having to hold the actuator 1. As soon as the gap 11 is to be closed again, the locking body 4 is turned with the screwdriver blade in the slot 14 against the direction of rotation 20 until the outer surfaces of the main body 2 and the locking body 4 are aligned with each other again, so that the rear grip of the locking body 4 in the recess 16 is deactivated again. The actuator 1 then automatically returns to its released initial position in the guide channel 15 against the actuating direction 13 due to the resetting spring force.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A cable connection device with a contact carrier, the cable connection device comprising:
a busbar;
a contact arm for fixing an electrical conductor between the busbar and the contact arm; and
an actuator cooperating with the contact arm, wherein the actuator is displaceably mounted in a guide channel in an actuating direction between a released position and an actuated position, and wherein the actuator is divided into a main body and a locking body in such a way that the locking body, in the actuated position of the actuator, is movable relative to the main body in a locking direction different from the actuating direction into a recess in an inner wall of the guide channel to form a rear grip to lock the actuator in the actuated position.

2. The cable connection device as claimed in claim 1, characterized by-wherein a longitudinal guide connecting the main body and the locking body and preferably running is configured to run at right angles to the actuating direction.

3. The cable connection device as claimed in claim 2, wherein the longitudinal guide is designed as a dovetail guide.

4. The cable connection device as claimed in claim 1, wherein a swivel joint connects the main body and the locking body.

5. The cable connection device as claimed in claim 1, wherein the main body and the locking body are initially firmly connected to one another and can only be moved relative to one another; after overcoming a resistance.

6. The cable connection device as claimed in claim 5, wherein the actuator has a predetermined breaking point between the main body and the locking body.

7. The cable connection device as claimed in claim 1, wherein the main body is arranged directly next to the contact arm or partially encloses the contact arm and the locking body is arranged above the main body as viewed in the actuating direction, and in that a tool engagement point (is formed into an end of the locking body facing away from the main body.

8. The cable connection device as claimed in claim 1, wherein a spring arm of a torsion spring is configured as the contact arm.

9. An actuator for a cable connection device, wherein the actuator is movably mounted in a guide channel of the cable connection device in an actuating direction between a released position and an actuated position, the actuator comprising:
a main body;
a locking body, wherein the locking body, in the actuated position of the actuator, is displaceable in a locking direction different from the actuating direction relative to the main body into a recess in an inner wall of the guide channel to form a rear grip to lock the actuator in the actuated position.
